(19) United States
(12) Patent Application Publication
(10) Pub. No.: US 2007/0178345 A1
(43) Pub. Date: Aug. 2, 2007

(54) Fuel cell module

(76) Inventors: Kenji Takeda, Hitachi (JP); Hironari Kawazoe, Hitachi (JP); Katsunori Nishimura, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/528,658

(22) Filed: Sep. 28, 2006

(30) Foreign Application Priority Data
Feb. 2, 2006 (JP) 2006-025198

(51) Int. Cl. H01M 8/04

(52) U.S. Cl. 429/23; 429/26

(57) ABSTRACT

A fuel cell module of the present invention includes a fuel cell stack and a power converter incorporated respectively in the casing. The power converter has a printed circuit board and a switching semiconductor. The printed circuit board is arranged between the switching semiconductor and the fuel cell stack, thereby cutting off the radiation of heat from the fuel cell stack to the switching semiconductor, and reducing the conduction loss of the switching semiconductor. Further, a high frequency transformer equipped with a Ferrite core is arranged on the side of the fuel cell stack of the printed circuit board, thereby reducing the iron loss in the high frequency transformer.

### CLAIM OF PRIORITY

The present application claims priority from Japanese application serial no. 2006-25198, filed on Feb. 2, 2006, the content of which is hereby incorporated by reference into this application.

### BACKGROUND OF THE INVENTION

1. Field of Technology The present invention relates to a fuel cell module using a fuel cell for generating electric power through chemical reaction.

2. Background of Art

In recent years, a fuel cell has been studied as an energy source reducing environmental loads. Use of the polymer electrolyte fuel cell (PEFC) has been studied to provide the energy source of a cogeneration system based on the heat and power thereof or as the power source of a motorized vehicle. The fuel cell is an apparatus for obtaining electromotive force through electrochemical reaction between the fuel gas mainly containing hydrogen and oxidizing gas. The electromotive force of one fuel cell is of the order, at most, of 0.7 volts. Thus, it is a common practice to laminate a few tens to a few hundred cells to create one fuel cell stack. The voltage of each of the fuel cells formed in a stack varies according to the density, humidity and temperature distributions of the fuel gas inside the stack, and voltage deterioration tends to vary according to each cell. Reduction of voltage in each cell may affect the service life and safety of the stack. Thus, the current generated by the fuel cell stack must be adjusted by monitoring the status of each cell. To meet this requirement, the Patent Document 1 discloses a cell voltage determining unit for monitoring the status of each of the fuel cells.

[Patent Document 1] Japanese Patent Laid-open No. 2003-297407 (paragraphs 0038 through 0042, and FIG. 2)

### SUMMARY OF THE INVENTION

### Problems to be Solved by the Invention

To design a system using the fuel cell stack, the generated current must be adjusted based on the technical know-how on the power generation characteristics of the fuel cell. This requirement has created problems with the system designing. The fuel cell stack is preferably arranged as a fuel cell module, wherein not only the cell voltage evaluation function but also the voltage converting apparatus electrically connected to the fuel cell stack are incorporated in one and the same casing, so that the aforementioned fuel cell module provides an automatic increase and reduction of the generated current of the fuel cell stack, based on the status of the fuel cell.

The voltage conversion apparatus controlled by the switching operation generally uses a switching semiconductor. When the polymer electrolyte fuel cell is used in the fuel cell stack, the fuel cell stack at the time of power generation reaches the temperature of 60° C. through 80° C. Thus, the switching semiconductor is characterized by an increase in the on-resistance with the rise of temperature. Thus, when the fuel cell stack and voltage conversion apparatus are incorporated in the same casing, the on-resistance of the switching semiconductor is increased by the temperature of the fuel cell stack. This may lead to increased losses.

The object of the present invention is to solve the aforementioned problems and to provide voltage conversion apparatus and a fuel cell module capable of restraining the adverse effect based on temperature of the fuel cell stack to the switching semiconductor, thereby reducing the loss of the switching semiconductor.

### MEANS FOR SOLVING THE PROBLEMS

The aforementioned object can be achieved by a fuel cell module having a DC-DC converter being incorporated in the casing surrounding a fuel cell stack to control the electrical output of the fuel cell stack, wherein an electrical circuit-mounted substrate of the DC-DC converter is arranged between the fuel cell stack and DC-DC converter.

### EFFECTS OF THE INVENTION

According to the present invention, it is possible to reduce losses in a DC-DC converter of a fuel cell module.

### BRIEF DESCRIPTION OF THE DRAWINGS

FIG. 1 is a cross section view representing a fuel cell module having the boost converter as a embodiment 1;

FIG. 2 is a structure diagram representing the overview of the fuel cell module as a embodiment 1;

FIG. 3 is a circuit diagram representing the circuit configuration of the boost converter be applying a fuel cell module as a embodiment 1; and

FIG. 4 is a diagram representing the temperature characteristics of the element loss inside the fuel cell module as a embodiment 1.

### DETAILED DESCRIPTION OF THE INVENTION

(Best Mode for Carrying Out the Invention)

The following describes the details of the embodiments of the present invention with reference to drawings:

### Embodiment 1

Referring to FIG. 2, the following describes the fuel cell module of the embodiment 1 of the present invention. The casing 11 of the fuel cell module incorporates a fuel cell stack 1 formed by lamination of a plurality of fuel cells, a boost converter 2 as voltage conversion apparatus for converting the output voltage of the fuel cell stack 1, a cell status monitoring substrate 3 of the fuel cells, and a connection cable 6. As shown in FIG. 2, the casing 11 is rectangular parallelepiped in the present embodiment. An approximately rectangular parallelepiped boost converter 2 is contained in this casing 11. The shape of the boost converter 2 in the casing 11 can be selected as desired, in response to the dimensions of the cells constituting the fuel cell stack 1. As shown in FIG. 2, a terminal board 13 as voltage output apparatus and a communication connector 12 as communication apparatus are provided on the same outside surface of the casing 11.

The casing 11 is connected with: fuel supply apparatus 8I for supplying a hydrogen-rich gas as a fuel gas of the fuel cell stack 1; exhaust gas exhaustion apparatus 80 for exhaustion of exhaust gas from the fuel stack 1 after hydrogen as part of the hydrogen-rich gas supplied from the fuel supply apparatus 8I has been consumed by the fuel cell stack 1; heating medium supply apparatus 9I for recirculating the heating medium for cooling the fuel cell stack 1; and heating medium exhaustion apparatus 90. Through these apparatuses, the casing 11 communicates respectively with a fuel gas system and a heat transmission system placed in the outside of the casing 11. As shown in FIG. 2, the fuel supply apparatus 8I, exhaust gas exhaustion apparatus 8O, heating medium supply apparatus 9I and heating medium exhaustion apparatus 9O are arranged on the same surface as that of the casing 11. This surface is located opposite the surface loaded with the terminal board 13 and communication connector 12.

When the fuel cell stack 1 is a polymer electrolyte fuel cell stack, for example, the operation temperature during generating power by the fuel cell stack 1 is of the order of about 70° C. through 80° C. Thus, in the present embodiment, all the surfaces of the fuel cell stack 1 is enclosed by insulation member 501, whereby propagation of heat into the boost converter 2 is reduced.

In the fuel cell module of the first embodiment, a heat radiation fin 502 as heat radiation apparatus is provided at a position removed away from the fuel cell stack 1 in the boost converter 2. A vent opening 503 is arranged on part of the surface of the casing 11 facing the boost converter 2. This arrangement reduces the adverse effect of heat generation of the fuel cell stack 1 upon the boost converter 2.

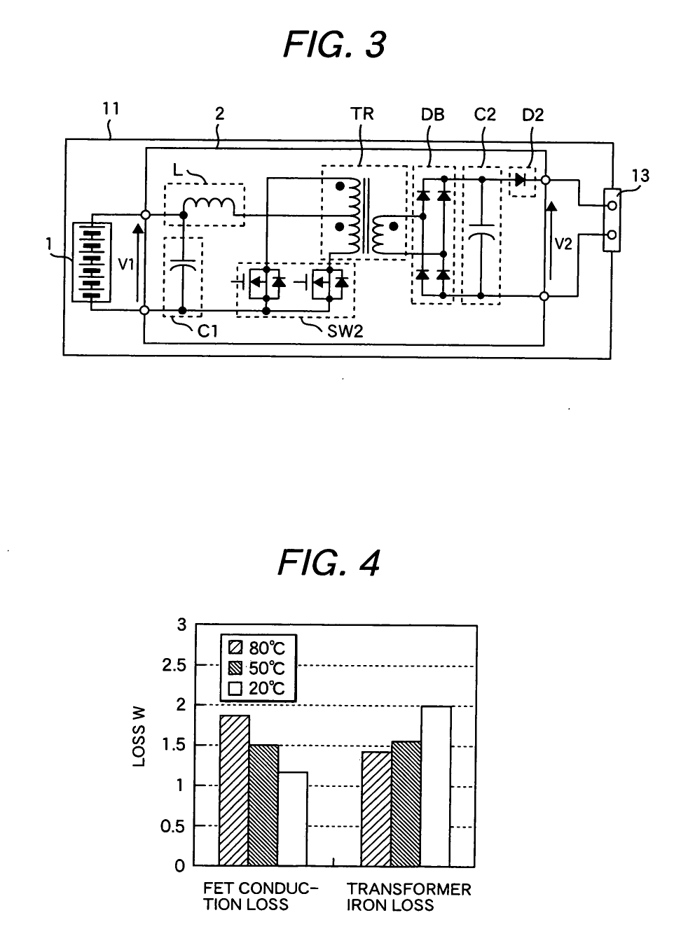

Referring to FIG. 3, the following describes the details of the boost converter 2 being applying the fuel cell module of the present embodiment. The input terminal V1 of the boost converter 2 is connected with both ends the fuel cell stack 1. Further, an input smoothing capacitor C1 is connected in parallel to the input terminal V1. The input smoothing capacitor C1 is connected with an input smoothing reactor L, the primary winding of a high frequency transformer TR and the series circuit of a switching semiconductor SW2 in parallel, as shown in FIG. 3. The details structure of the switching semiconductor SW2 is shown in FIG. 3. Both ends of the secondary winding of the high frequency transformer TR are connected with the output smoothing capacitor C2 through output rectification apparatus DB. An output terminal V2 is connected with the output smoothing capacitor C2. In this case, to prevent current flowing from the output terminal V2 in the direction of charging the output smoothing capacitor C2, a back flow prevention apparatus D2 can be connected between the output terminal V2 and the output smoothing capacitor C2. The output terminal V2 shown in FIG. 2 is electrically connected with the terminal board 13.

Here, in the boost converter 2, a ceramic capacitor or electrolytic capacitor may be used as the input smoothing capacitor C1 and output smoothing capacitor C2. A power MOSFET or IGBT can be used as the switching semiconductor SW2. Diodes can be used as the output rectification apparatus DB and back flow prevention apparatus D2. To absorb various forms of magnetic noise, noise filtering circuits may be connected in series or in parallel between the input terminal V1 and output terminal V2, or with respect to the ground, although it is not illustrated. In an example of the boost converter shown in FIG. 3, an electric circuit structure of the input is shown as a push-pull type current converter, and a rectifier circuit structure of the output is indicated as a full bridge type rectifier circuit. However, any circuit structure is acceptable just as long as there is a boost converter circuit for converting the input/output voltages by switching of the switching semiconductor SW2.

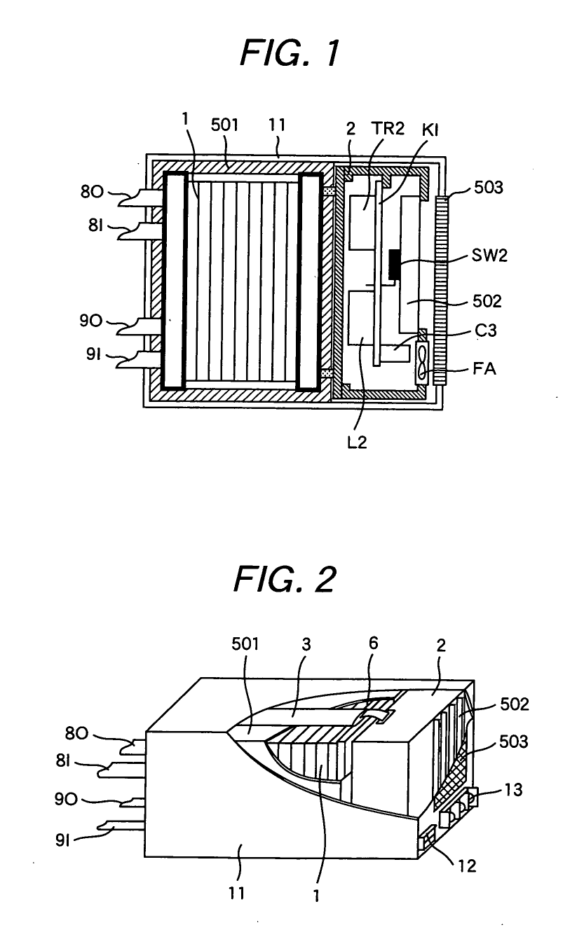

Referring to FIG. 1 the following describes the parts arrangement in the boost converter 2 in the present embodiment. FIG. 1 represents a cross section of the fuel cell module shown in FIG. 2. As shown in FIG. 3, the fuel cell stack 1 is covered with the insulation member 501, and in the casing 11, the boost converter 2 is connected with the fuel cell stack 1. The casing 11 covers the insulation member 501 and the boost converter 2. The boost converter 2 has a heat radiation fin 502. The portion of the casing 11 facing the heat radiation fin 502 is provided with the vent opening 503. A printed circuit board K1 as an electrical circuit-mounted substrate, a high frequency transformer TR2, an input smoothing reactor L2, a switching semiconductor SW2 and a capacitor C3 are incorporated in the boost converter 2. The capacitor C3 shown in FIG. 1 corresponds to the input smoothing capacitor C1 and/or output smoothing capacitor C2 shown in FIG. 3. If required, a fan FA for ventilation inside the boost converter 2 can be provided to supply air as a cooling medium.

In present invention, the terminal of the switching semiconductor SW2 inside the boost converter 2 is connected to the printed circuit board KI, on the one hand. On the other hand, to transmit heat to the heat radiation fin 502, the switching semiconductor SW2 is fixed to the heat radiation fin 502 with screws and others. In the boost converter 2, arrangement is made in such a way that the relationship between the minimum distance W1 between the printed circuit board KI and fuel cell stack 1 and the minimum distance W2 between the chip of the switching semiconductor SW2 and fuel cell stack 1 is W2>W1. To be more specific, the chip of the switching semiconductor SW2 is placed and fixed at a position farther than the printed circuit board KI relative to the surface of the fuel cell stack 1. The printed circuit board KI is arranged between the fuel cell stack 1 and the switching semiconductor SW2. This ensures that radiant heat from the fuel cell stack 1 to the switching semiconductor SW2 is cut off by the printed circuit board KI, whereby temperature rise in the switching semiconductor SW2 is restrained.

The loss occurring to the switching semiconductor SW2 is exemplified by the conduction loss caused by the on-resistance of the switch. This on-resistance is depends on the chip temperature. Rise in chip temperature may involve an increase in the loss. The chart shown in FIG. 4 represents the relationship between the loss of the switching semiconductor SW2 in the circuit-configuration shown in FIG. 3, and the chip temperature. As shown in FIG. 4, the loss at the chip temperature of 80° C. is about 1.6 times that at the chip temperature of 20° C. This suggests that the temperature of the switching semiconductor SW2 should be reduced to the lowest possible level in order to minimize the loss. Thus, as has been mentioned, because the printed circuit board KI is placed between the fuel cell stack 1 and the switching semiconductor SW2 (FIGS. 1 and 3), the temperature rise of the switching semiconductor SW2 is restrained. Accordingly, the loss occurring to the switching semiconductor SW2 is reduced, whereby the conversion efficiency of the boost converter 2 is increased.

The high frequency transformer TR2 and the input smoothing reactor L2 are electrically connected with the terminal on the printed circuit board KI. In this case, the relationship between the shortest distance W3 between the high frequency transformer TR2 or the input smoothing reactor L2 and the fuel cell stack 1, and the shortest distance W4 between the printed circuit board KI and the fuel cell stack 1 is W4>W2. To be more specific, the printed circuit board KI is arranged and fixed at a position father than the high frequency transformer TR2 or the input smoothing reactor L2 relative to the distance from the surface of the fuel cell stack 1. In other words, the high frequency transformer TR2 or the input smoothing reactor L2 are placed on the plane surface connecting between the printed circuit board KI and fuel cell stack 1. In this arrangement, the radiant heat produced from the fuel cell stack 1 is cut off by the printed circuit board KI, whereby the temperature of the high frequency transformer TR2 and input smoothing reactor L2 is increased.

When the winding element of the high frequency transformer TR2 and the input smoothing reactor L2 uses a magnetic core, iron loss occurs due to the change in the density of magnetic flux inside the magnetic core. The iron loss of the magnetic core (particularly, the core made of Ferrite) depends on the core temperature. There is the core temperature wherein the iron loss is the minimum. The chart shown in FIG. 4 represents the change in the iron loss of the high frequency transformer TR2 caused by core temperature in the circuit structure of FIG. 3. As shown in FIG. 4, the loss at the core temperature of 80° C. is reduced about 25% as compared to that at the core temperature of 20° C. This suggests that the high frequency transformer TR2 should be raised to the highest possible level in order to minimize the loss. Thus, the high frequency transformer TR or input smoothing reactor L shown in FIG. 3 is arranged as in the case of the high frequency transformer TR2 or the input smoothing reactor L2 shown in FIG. 1; namely, the distance from the surface of the fuel cell stack 1 is arranged in such a way that the printed circuit board KI is fixed farther than the high frequency transformer TR2 or input smoothing reactor L2. This arrangement promotes temperature rise of the magnetic core and reduces the iron loss occurring to the high frequency transformer TR2 or the input smoothing reactor L2, thereby increasing the conversion efficiency of the boost converter 2.

What is claimed is:

1. A fuel cell module, comprising:
a fuel cell stack;
a DC-DC converter to control the electrical output of said fuel cell stack; and
a casing incorporated said fuel cell module and said DC-DC converter,
wherein said DC-DC converter includes an electrical circuit-mounted substrate provided with the switching semiconductor, and said electrical circuit-mounted substrate is arranged between said fuel cell stack and said switching semiconductor.

2. A fuel cell module according to claim 1, wherein said DC-DC converter is equipped with heat radiation apparatus, and said switching semiconductor is arranged between said electrical circuit-mounted substrate and heat radiation apparatus.

3. A fuel cell module according to claim 1, wherein said switching semiconductor is either a power MOSFET or IGBT.

4. A fuel cell module according to claim 1, wherein said fuel cell module is a polymer electrolyte fuel cell module.

5. The power generation system using the fuel cell module according to claim 1, wherein said heat radiation apparatus is provided with a cooling medium.

6. A fuel cell module, comprising:
a fuel cell stack;
a DC-DC converter to control the electrical output of said fuel cell stack; and
a casing incorporated said fuel cell module and said DC-DC converter,
wherein said DC-DC converter is equipped with a switching semiconductor, an inductor, a transformer, and an electrical circuit-mounted substrate provided with said switching semiconductor, said inductor and said transformer;
said electrical circuit-mounted substrate is arranged between said fuel cell stack and said switching semiconductor; and
said transformer and inductor are arranged between said fuel cell stack and said electrical circuit-mounted substrate.

7. A fuel cell module according to claim 6, wherein said inductor and transformer have a Ferrite magnetic core.

8. A fuel cell module according to claim 6, wherein said fuel cell module is a polymer electrolyte fuel cell module.

9. The power generation system using the fuel cell module according to claim 6, wherein said heat radiation apparatus is provided with a cooling medium.

10. A fuel cell module, comprising:
a fuel cell stack;
a DC-DC converter to control the electrical output of said fuel cell stack; and
a casing incorporated said fuel cell module and said DC-DC converter,
wherein said DC-DC converter is equipped with a switching semiconductor, a smoothing capacitor, and an electrical circuit-mounted substrate provided with said switching semiconductor and said smoothing capacitor;
said electrical circuit-mounted substrate is arranged between said fuel cell stack and said switching semiconductor; and
said smoothing capacitor is mounted on the same side of the electrical circuit-mounted substrate as that of the switching semiconductor.

11. A fuel cell module according to claim 10, wherein said switching semiconductor is either a power MOSFET or IGBT.

12. A fuel cell module according to claim 10, wherein said smoothing capacitor is an electrolytic capacitor.

13. A power generation system using the fuel cell module according to claim 10, wherein said heat radiation apparatus is provided with a cooling medium.
